(19) United States
(12) Patent Application Publication
(10) Pub. No.: US 2008/0235317 A1
(43) Pub. Date: Sep. 25, 2008

(54) System and Method For Providing an Extended Computing Capacity

(76) Inventor: Tom Burgmans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/597,429

(22) PCT Filed: Jan. 25, 2005
(86) PCT No.: PCT/IB2005/050302

§ 371 Date: Jul. 25, 2006

Related U.S. Application Data
(60) Provisional application No. 60/539,782, filed on Jan. 27, 2004.

(51) Int. Cl. G06F 15/16

(52) U.S. Cl. 709/201

(57) ABSTRACT

A system, method and business model is disclosed in which computation and storage intensive tasks are performed using remote commercial products (13) of a product manufacturer (80) rather than with centralized resources (10) owned by the product manufacturer (80). The present invention uses the spare resources (e.g., processing, storage) of commercial products (13) of a product manufacturer (80) without impacting the products stated performance. The owners of the commercial products (13) may receive reward credits for voluntarily participating in the distributed processing system (100). The reward credits may be redeemable in any number of ways, including, for example, the purchase of future products of the product manufacturer, merchandise, resort packages, airline travel and so on. In one aspect, the product manufacturer (80) may contract out the services of the commercial products sold by the manufacturer (80) to third parties to complete their large processing tasks.

The present invention provides a system and method for distributed computing using spare resources of commercial products sold by a product manufacturer.

Distributed computing is a technique for harnessing idle computing power available through large networks such as the Internet. One such example is the Search for Extraterrestrial Intelligence (“SETI”), a project in which millions of computers connected to the Internet process astronomical data in an effort to identify signs of extraterrestrial life. The network of computers all work simultaneously on different parts of the analysis. In operation, the process is performed in a background mode. More particularly, the computers download a client application that is used as a screensaver. When the screensaver becomes active, data is downloaded from a SETI server and analysis of the data is performed on the client computer using the client application. The results of the analysis are then reported back (uploaded) to the SETI server.

Another example of a distributed processing technique was developed and implemented by Distributed.net (URL in March 2000—www.distributed.net) to compete in encryption breaking contests. Distributed.net created and distributed a client software program which may be downloaded by client systems connected to the Internet. The client software then acts as part of a large distributed processing system specifically designed to break encrypted messages on the Internet.

Increasingly, retail products sold by a product manufacturer do not come close to fully utilizing their resources (e.g., processor, memory, hard-disk space). It would therefore be desirable to utilize the unused resources to effectively extend the computing capacity of a product manufacturer in completing large computational tasks.

The present invention provides a system, method and business model in which computation and storage intensive tasks are performed using remote commercial products of a product manufacturer rather than with centralized resources owned by the product manufacturer. The present invention uses the spare resources (e.g., processing, storage) of commercial products of a product manufacturer without impacting the products stated performance.

According to one aspect of the invention, for those commercial products used in accordance with the principles of the invention, the owner of the commercial product may receive reward credits. The reward credits may be redeemable in any number of ways, including, for example, the purchase of future products of the product manufacturer, merchandise, resort packages, airline travel, gift certificates of specified value from third party sources, unlimited warranty and service for existing product devices, free telephone minutes, lottery chances and the like.

According to a further aspect of the invention, the product manufacturer may contract out the services of the commercial products sold by the manufacturer to third parties to complete their large processing tasks.

According to another aspect of the invention, a method for distributed computing comprises the acts of: decomposing, at a main processor (server), a large programming task into a plurality of work tasks; and receiving requests from a plurality of remote product devices for work tasks to be processed therein; distributing the plurality of work tasks to the product devices; receiving work task results from the product devices; and combining the work task results at the main processor (server) to yield an overall processing result of a large programming task of the product manufacturer or third party.

According to yet another aspect of the invention, a system for processing a large programming task by a plurality of remote product devices, the system comprising: a main processor (server) configured to decompose a large programming task into a plurality of work tasks, receive requests from said plurality of remote product devices (13), distribute the work tasks to requesting product devices, receive work task results from the product devices; and combine the work task results to yield an overall processing result of the large programming task. The system further comprises a database for storing product device preference and capability data for each remote product device.

Referring now to the drawings in which like reference numbers represent corresponding parts throughout, where:

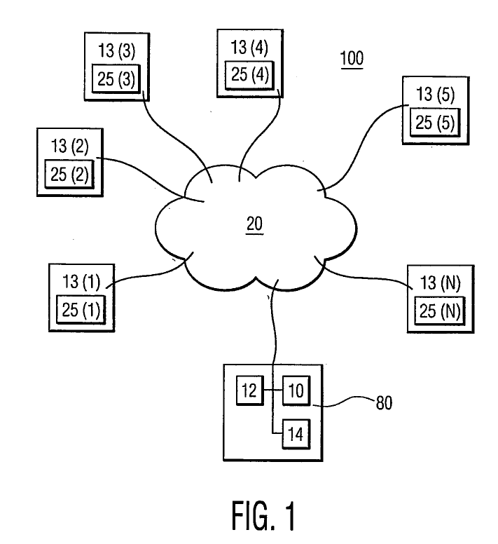

FIG. 1 is an overview of a system including a scheduler for distributing tasks to a number of product devices; and

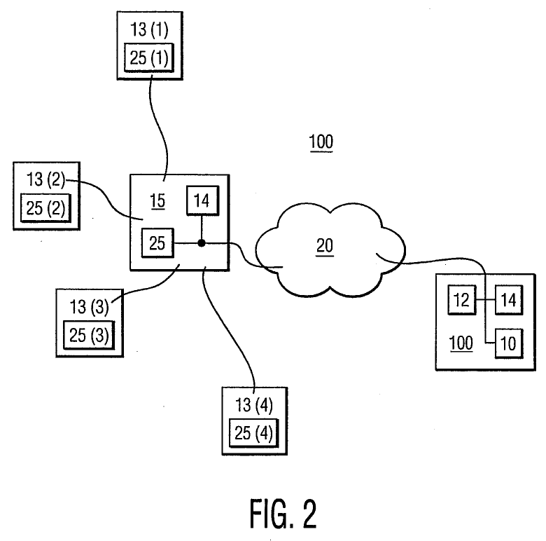

FIG. 2 is an illustration of a product device serving as a network node for a number of co-located product devices.

In the following description of the specific embodiments, reference is made to the accompanying drawings which form a part hereof and which show by way of illustration the specific embodiments in which the invention may be practiced. In the accompanying drawings, like reference numbers represent corresponding parts throughout the several views. It is to be understood that other embodiments may be utilized as structural changes may be made without departing from the scope of the invention.

Product manufacturers such as, for example, the Philips Corporation™ of North America sell a vast array of commercial products at the retail level to consumers throughout North America and the world. Like all product manufacturers, Philips™ is tasked with processing large programming tasks internally associated with day to day business concerns. Such tasks can tax and sometimes overwhelm the internal computing resources of large corporations like Philips. The present invention provides a solution to the ever increasing demands placed upon the internal computing resources of entities like Philips by utilizing the unused processing/storage capabilities of the vast array of commercial products sold by the product manufacturing entity to assist in completing large programming tasks suitable for distributed computing. As an incentive for participating, the product owners may be offered various incentives such as receiving discount credits towards the purchase of future products in proportion to the amount of work/time devoted by the product to the assigned work tasks. In the case where the product is a television/set-top box, the owner may be rewarded with free audio/video content in proportion to the amount of work/time allotted to the distributed programming task. Rewards may also take the form of monetary incentives, unlimited warranty and service for the existing product device, third-party incentives such as, free telephone minutes and other third-party products and so on. As a further example, the reward could also be tied into a lottery system whereby the more work/time allotted translates into additional chances for winning a lottery prize. It will further be appreciated by those skilled in the art that although various types of reward schemes have been explicitly described herein there are many other forms of reward schemes that could also work.

With reference now to the figures, and in particular to FIG. 1, one embodiment of the present invention is a system 100 for distributed computing which includes a product manufacturer entity 80 including a main processor (or main server) 10, a distribution management function 12 for managing the distributed processing task and a database 14 for storing at least capability and preference data. The main processor (server) 10 may be any suitable server computer system or other processor system programmed or configured to perform large programming tasks. System 100 further includes a plurality of remote product devices 13(1), 13(2), . . . , 13(N), where each product device 13 includes an associated client management function 25 (1), 25(2), . . . , 25(N), to be described below. The product devices 13 communicate with the product manufacturer entity 80 over a network 20.

The product devices 13 represent the vast array of products produced and sold by the product manufacturer to consumers. The product devices 13 may include, for example, DVD recorders, Digital TV's, set-top boxes, Internet radios as well as specialty devices such as cell phones, a microwave or other appliances. The capabilities of the various product devices 13 may span the entire range of possible computing, processing and storage capabilities. For example, the product devices 13 capabilities/configurations may include: central processing units (CPUs), digital signal processors (DSPs), graphics processing engines (GPEs), hard drives (HDs), memory (MEM), audio subsystems (As), communications subsystems (CSs), removable media types (RMs), and other accessories with potentially useful unused capabilities. The number of product devices 13 contemplated by the present invention is very large, i.e., on the order of thousands to tens of thousands of products.

In a preferred embodiment, the large programming task to be solved may be that of the product manufacturer entity (80). In other embodiments, the large programming task may be that of a third party entity with whom the product manufacturer entity (80) has contracted the computing services of the programming devices 13. In this case, the product devices 13 interact with a third party entity (80).

The network 20 is any network, or combination of networks, that allow the product devices 13 to communicate with the product manufacturer entity (80). For example, network 20 can be the Internet, a wireless transmission network, a wired transmission network, or any combination.

Client program 25 controls the functionality of the product device 13 to perform activities associated with the distributed processing system of the invention (e.g., accepting work tasks, controlling the processing of work tasks, etc.). As such, if an owner decides not to participate, the owner has the option of switching the client program 25 off, assuming that the client program 25 has been previously installed.

In one embodiment, the client program 25 may be automatically installed at the factory in each product device 13. In another embodiment, the client program 25 is downloaded from the product manufacturer entity (80). In yet another embodiment, the product owner could give permission to allow the client program 25 to be downloaded. This type of installation could occur, for example, at a point in time at which the product device 13 establishes a connection to the product manufacturer's server 10 to obtain updates, revisions, enhancements, modifications, audio/video streams and the like.

It is to be appreciated that the particular form of the client program 25 installed in each product device 13 may vary according to the particular product device 13.

The client program 25 may be stored in a memory of the product device 13, for example a hard drive or other computer-readable media, such as secondary storage devices, like hard disks, floppy disks, and CD-ROM; or other forms of ROM or RAM.

The client program 25, operates in a background mode in the product device 13 and does not impact the products performance. That is, the resources that are dedicated to the product performance are not shared in any way to perform activities associated with the invention. The invention only utilizes otherwise idle resources of the product device 13. For example, for those product devices 13 that operate in accordance with a task priority hierarchy, the client program 25 always operates with the lowest possible priority only utilizing resources which would otherwise go unused by the product device 13.

The client program 25 includes a number of preference settings which are preferably stored in the database 14 associated with the product manufacturing entity (80). The preference settings are described in Table I below, according to one embodiment.

TABLE I

| Preference | | |
|---|---|---|
| Setting | Parameter Name | Description |
| To Accept or | A/R | Determines whether the product |
| reject work tasks | | device 13 will accept or reject |
| | | work tasks from the central |
| | | computer |
| Processing time | Proc-time-alloc | Determines the amount of |
| allocation | | processing time to be allocated by |
| | | the program device 13 to a work |
| | | task |
| Disk-space | Disk-alloc | Determines how much disk space |
| allocation | | is to be allocated by the program |
| | | device 13 to a work task |
| Main processor | Poll-freq | Determines the frequency for |
| polling frequency | | querying the main processor |
| | | (server) 10, including other polling |
| | | option (see below) |
| Memory | Mem-alloc | Determines how much memory |
| allocation | | space is to be allocated by the |
| | | program device 13 to a work task |
| CPU usage | CPU-usage | Determines the percentage of CPU |
| | | usage will be allocated by the |
| | | program device 13 to a work task |
| Type of reward | Type-reward | Determines the type of award in |
| | | exchange of processing work tasks |
| Type of | Type-work-tasks | Determines the type of work tasks |
| work tasks | | to be processed by the product |
| | | device. (this option is applicable if |
| | | there are different type of rewards |
| | | coupled to different kind of work |
| | | task types) |
| Process tasks only | Stby-mode | Determines whether the product |
| if device is in | | device 13 will process work tasks |
| standby mode | | only when it is in standby mode or |
| | | otherwise. |
| Automatically | Autom-process/ | Determines whether the product |
| process task/ask | ask-perm | device 13 will process a dedicated |
| permission | | task automatically or will ask for |
| | | user permission to start processing. |
| Resume old tasks/ | Resume/no- | Determines whether the product |
| start new one | resume | device 13 will resume an old, not |
| | | finished work task (after a reboot) |
| | | or will erase the old data and ask |
| | | for a new work task. |

The operation of a distributed computer system of the invention having the foregoing configuration will now be described.

First, a large programming task of a product manufacturer 80 is identified and selected by the product manufacturer entity (80) as being suitable for distributed computing in accordance with the principles of the invention. Once selected, the identified and selected large programming task is decomposed into a plurality of smaller work tasks by the main processor (server) 10, suitable for processing by the remote product devices 13. The process of decomposing the large programming task is performed under control of the distribution management function 12 of the product manufacturer entity (80). Each work task is analyzed by the main processor (server) 10 to determine and assign an estimated time of completion. The distribution management function 12 also schedules the work tasks in a processing queue to be completed in a precise order. The product devices 13 request work tasks from the product manufacturing entity (80) on a pull basis (e.g., initiated by the product device 13).

Referring now to Table I, the “poll-freq” preference setting describes the frequency with which a product device 13 polls the product manufacturing entity (80) to establish a communication session. The “poll-freq” parameter in client program 25 can be set to poll the product manufacturing entity (80) as often as every X seconds or as infrequently as every X days or weeks. The “poll-freq” parameter may be adjusted in the client program 25 in accordance with a number of criteria including, for example:
poll more frequently when the product device 13 is in a standby mode.
poll more frequently when the product device 13 is in a state where the cpu/memory usage is low.
poll more frequently when a certain amount of disk space is available.
poll only after a product device 13 system reboot.
no automatic polling (poll-freq=0), only manual.
no polling while a work task is currently being processed.
continue polling while a work task is being processed.
if the product device 13 is a TV or set-top box, polling is initiated by the audio/video content (e.g., by the TV broadcaster/DVD).
poll only when the main processor (server) 10 is contacted for a reason other than requesting a work task (e.g. software update).

It is to be appreciated that the polling criteria described above is exemplary of the possible polling criteria which may be used.

At each communication session between a product device 13 and the main processor (server) 10, the product device 13 first identifies itself to the main processor (server) 10 by communicating its product device identifier (PID). The PID can be any suitable identification provided by the product manufacturer during manufacture to uniquely identify each manufactured product device 13.

Once the product device 13 is successfully identified by the main processor (server) 10 via its PID, the PID is then used by the product manufacturing entity (80) to attempt to retrieve the product device's 13 capabilities from the product manufacturer database 14. In the case where a capabilities profile is not located in the database 14 for the particular product device 13, the main processor (server) 10 will request that the product device 13 transfer its capabilities to the main processor (server) 10. Capabilities include, for example, the product device's operating system, the release version of current software applications used in the product device, specific software applications, peripherals (e.g., modems, CDROM/DVD player, extra hard-disks, extra processors). The transferred product device 13 capabilities, once transferred, are stored and maintained in the product manufacturer database 14 and updated as necessary. In one embodiment, whenever a product device's capabilities are changed, a capabilities update notification may be issued by the product device 13 to the main processor (server) 10 informing it of the change. A flag may be set in the main processor (server) 10 subsequent to receiving the update notification so that at the next established communication session with the product device 13, its capabilities are automatically transferred and stored in the product manufacturer entities 80 database 14 as a single record.

Having established the product device's capabilities, the main processor (server) 10 then uses the PID once more as an index into the product manufacturer database 14 to attempt to retrieve the product device's preference settings (see Table I). In the case where the preference settings are not located for the particular product device 13, the main processor (server) 10 will request that the product device 13 transfer its preference settings to the main processor (server) 10. The transferred preference settings for the particular product device 13 are stored and maintained in the product manufacturer's database 14 as a single record. If at any point the preference settings of a product device 13 are changed, then a preferences update notification is issued by the product device 13 to the main processor (server) 10 informing it as such. A flag may be set in the main processor (server) 10 subsequent to receiving the update notification so that at the next communication session with the product device 13, its preference settings are automatically transferred and stored in the product manufacturer database 14.

Having established the product device 13 capabilities and preference settings, the main processor (server) 10, at this point, has obtained sufficient information about the product device 13 to determine whether or not to issue one or more work tasks to the product device 13 from the processing queue. The main processor (server) 10 assigns or does not assign a work task by comparing the defined capabilities and preference settings of the product device 13 with the current work tasks in the processing queue. If the result of the comparison results in a determination that the product device 13 is suitable to receive one or more work tasks then one or more work tasks suited to the product device 13 are assigned. After assigning each work task, the main processor (server) 10 monitors the time of assignment and starts a counter to determine if the product device 13 returns the assigned work task within the previously computed estimated time of completion.

FIG. 2 is an illustration of a product device 15 serving as a standalone product device 15, as previously described, and also as a network node for a plurality of co-located product devices. By way of example, product device 15 may be embodied as a set top box 15 located in a household environment. The co-located product devices 13 (1), . . . , 13(4) may be, for example, household product devices such as a DYD 13(1), an Internet radio 13(2), a camcorder 13(3) and a microwave 13(4) or any other common household appliance including processing/storage capabilities. Product device 15 performs a number of network coordination activities on behalf of the co-located product devices 13(1), . . . , 13(4), including distributing/rejecting work tasks to the other co-located product devices 13(1), . . . , 13(4), and returning work task results from the co-located product devices 13(1), . . . , 13(4) back to the main processor (server) 10. Product device 15 may have a different client program 25 software configuration to implement its additional duties as a network node.

To insure that the results of assigned work tasks are returned to the main processor (server) 10 by the product devices 13 in a timely fashion, a number of safe-guards may be employed by the main processor (server) 10. First, the main processor (server) 10 has the option of assigning any work task redundantly. That is, a work task may be assigned to two or more product devices 13 recognizing that there will be occurrences in which a work task will not be returned by a product device 13. This option may be especially useful for those work tasks that the main processor (server) 10 marks as critical. Secondly, as mentioned above, each assigned work task has an associated estimated time of completion that is monitored by the main processor (server) 10. In the event an assigned work task is not returned by a product device 13 within the estimated completion time, the main processor (server) 10 has the option of automatically re-assigning the work task to another product device 13 for completion. A completed work task that is received by the main processor (server) 10 in excess of its estimated completion time may be ignored by the main processor (server) 10 if the re-assigned work task is completed and returned in a timely manner. Additionally, a signal or message may be sent from the main processor (server) 10 to the originally assigned product device 13 informing it to discard it's work task result as being untimely.

It will be apparent to those of skill in the art that the disclosed apparatus and method has numerous applications in the area of wireless data networking.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A method for processing a large programming task by a plurality of remote product devices (13) of a product manufacturing entity (80), the method comprising the acts of:
decomposing, at a main processor (server) (10) of said product manufacturing entity (80), said large programming task into a plurality of work tasks; and
receiving requests from said remote product devices (13) for said work tasks;
distributing said work tasks to said product devices (13), responsive to said received requests;
receiving work task results from said product devices (13); and
combining said work task results at said main processor (server) (10) to yield an overall processing result of said large programming task.

2. The method of claim 1, wherein said decomposing act further comprises computing, at said main processor (server) (10), an estimated time of completion for each of said plurality of work tasks.

3. The method of claim 2, further comprising the act of re-distributing a work task to a different product device in the case where a work task result is not returned to said main processor server (10) within its estimated time of completion.

4. The method of claim 1, wherein said act of receiving requests from said remote product devices (13) for said plurality of work tasks further comprises the act of polling said main processor (server) (10) on a scheduled basis to establish a communication session with said main processor (server) (10).

5. The method of claim 2, wherein said scheduled basis is determined in accordance with a polling frequency parameter defined in each of said product devices (13).

6. The method of claim 5, wherein said polling frequency parameter may be modified in said product device (13) in accordance with at least one of: (i) determining that said product device (13) is in a standby mode, (ii) determining that said product device (13) is in a state of low CPU and/or memory usage, (iii) determining that said product device (13) is undergoing a system reboot, (iv) determining that said product device (13) is currently processing a work task, (v) determining that said product device (13) has predetermined amount of disk space available for use.

7. The method of claim 1, further comprising, prior to said distributing act, the acts of:
comparing, at said main processor (server) 10, said capabilities and preference settings of said requesting product device's with work tasks to be distributed; and
determining, based on said comparison, whether said requesting product device is suitable for receiving one or more work tasks from said main processor (server) 10.

8. The method of claim 7, further comprising, prior to said comparing act, one of (i) retrieving said product device's capabilities and preference settings from a product manufacturer entity (80), database (14); and (ii) transferring said product device's capabilities and preference settings from said product device (13) to said product manufacturing entity (80).

9. The method of claim 1, wherein the act of decomposing said large programming task into a plurality of work tasks further comprises the act of identifying, at the main processor (server) 10, certain of said plurality of work tasks as critical work tasks.

10. The method of claim 9, wherein said critical works tasks are redundantly distributed by said to two or more remote product devices 13.

11. The method of claim 1, further comprising the act of providing reward points to product owners of said plurality of product devices (13) in proportion to the amount of processing resources expended to process said work tasks.

12. The method of claim 11, wherein a reward point total count is maintained by said main processor (server) 10 for each for said product devices (13) in a database (14).

13. The method of claim 11, wherein said award points are redeemable for items selected from the group of items comprising: discounts toward the purchase of future products of the product manufacturer entity (80), merchandise, resort packages, airline travel, gift certificates of specified value from third party sources, unlimited warranty and service for existing product devices, free telephone minutes, and lottery chances.

14. A system (100) for processing a large programming task comprising:
a product manufacturing entity (80) comprising:
a main processor (server) (10) configured to decompose said large programming task into a plurality of work tasks, receive requests from said plurality of remote product devices (13), distribute said plurality of work tasks to said product devices (13), receive work task results from said product devices (13); and combine said work task results to yield an overall processing result of said large programming task; and
a database (14) for storing the product device capability data for each of said plurality of remote product devices (13); and
a plurality of remote product devices (13) configured to request work tasks from said product manufacturing entity (80), process said work tasks and return work task results to said product manufacturing entity (80).

15. The system (100) of claim 14, wherein said main processor (server) (10) is further configured to determine an estimated time of completion for each of said plurality of work tasks and identify certain of said plurality of work tasks as critical work tasks.

16. The system (100) of claim 14, wherein the main processor (server) 10 is any suitable server computer or processor system configured to perform large programming tasks.

17. The system (100) of claim 14, wherein said product manufacturer entity (80) further includes a distribution management function (12) configured to manage the decomposition of said large programming task into a plurality of work tasks, manage the reception of requests from said plurality of remote product devices (13), manage the distribution of said plurality of work tasks to said product devices (13), manage the reception of received work task results from said product devices (13); and manage the combination of said work task results to yield an overall processing result of said large programming task.

18. The system of claim 12, wherein each of said plurality of remote product devices (13) includes a client program (25) for managing the reception of work tasks, managing the processing of work tasks and for managing the return of work task results to said product manufacturing entity (80).

19. The system of claim 12, wherein said client program (25) includes a plurality of preference settings, comprising: (a) an accept/reject work task setting, (b) a processing time allocation setting, (c) a disk space allocation setting, (d) polling frequency setting, (e) a memory allocation setting, (f) a CPU usage type setting, (g) reward type setting (h) a work task type setting (i) a standby mode type setting, (j) an automatic processing type setting, and (k) a resume old task type setting.
